(19) United States
(12) Patent Application Publication
(10) Pub. No.: US 2014/0249721 A1
(43) Pub. Date: Sep. 4, 2014

(54) Steering System For A Motor Vehicle

(71) Applicants: Wolfgang Schindler, Regenstauf (DE); Thomas Gallner, Regensburg (DE); Thomas Raste, Overursel (DE)

(72) Inventors: Wolfgang Schindler, Regenstauf (DE); Thomas Gallner, Regensburg (DE); Thomas Raste, Overursel (DE)

(21) Appl. No.: 14/128,711

(22) PCT Filed: Jun. 28, 2012
(86) PCT No.: PCT/EP2012/062599

§ 371 Date: Mar. 24, 2014

(30) Foreign Application Priority Data
Jul. 22, 2011 (DE) 10 2011 079 668.1

(51) Int. Cl. B62D 15/02

(52) U.S. Cl. CPC B62D 15/025
USPC 701/41

(57) ABSTRACT

A steering system for a vehicle that includes actuators for a wheel drive, steering, and suspension may include (a) a request level configured to determine a desired movement vector, (b) a control level, to which for each predetermined movement direction of the motor vehicle one control unit is assigned, each control unit being configured to determine a force vector as a function of the desired movement vector, and (c) an actuation level configured to determine respective control variables for the actuators as a function of the determined force vectors.

### CROSS-REFERENCE TO RELATED APPLICATIONS

This application is a U.S. National Stage Application of International Application No. PCT/EP2012/062599 filed Jun. 28, 2012, which designates the United States of America, and claims priority to DE Application No. 10 2011 079 668.1 filed Jul. 22, 2011, the contents of which are hereby incorporated by reference in their entirety.

### TECHNICAL FIELD

The invention relates to a steering system for a motor vehicle having actuators for the wheel drive, steering and suspension.

### BACKGROUND

In contemporary motor vehicles, devices which register the predefined values of a motor vehicle driver for the movement of the motor vehicle are predominantly coupled directly to the actuators for the drive, brake, suspension and steering. Contemporary motor vehicles also have a multiplicity of control units for driver assistance systems, which are also coupled directly to the actuators. In many cases these driver assistance systems have control units which have to be matched to one another. This coupling of the control units makes it more difficult to expand and/or change the driver assistance system functions and/or the actuators.

### SUMMARY

One embodiment provides a steering system for a motor vehicle having actuators for the wheel drive, steering and suspension, comprising: (a) a request level which is assigned: first registering units which are each designed to register continuous predefined values of a vehicle user for a movement of the vehicle, and/or second registering units which are each designed to register time-discrete predefined values of the vehicle user for the movement of the motor vehicle; a first processing unit configured to determine a preliminary setpoint movement vector for the motor vehicle as a function of the registered continuous and/or time-discrete predefined values of the vehicle user; third registering units which are each designed to determine at least one current and/or predictive operating variable for the motor vehicle; a second processing unit configured to determine a setpoint movement vector for the motor vehicle as a function of the preliminary setpoint movement vector and the determined operating variables; (b) a monitoring level which is assigned a control unit for each of the predefined movement directions of the motor vehicle, wherein the control units are each designed to determine a force vector as a function of the setpoint movement vector and at least one predefined parameter set for a predefined system control function; and (c) an actuation level which is assigned at least one third processing unit configured to determine respective manipulated variables for the actuators as a function of the determined force vectors.

In a further embodiment, at least one third processing unit is designed to determine the respective manipulated variables for the actuators as a function of a current and/or predictive operating variable.

In a further embodiment, the setpoint movement vector represents a curvature and an acceleration.

In a further embodiment, the monitoring level is respectively assigned at least one control unit for a lateral, a vertical and a longitudinal movement direction of the motor vehicle.

In a further embodiment, the control unit has more than one controller for the lateral movement direction and/or the control unit has more than one controller for the vertical movement direction and/or the control unit has more than one controller for the longitudinal movement direction, wherein the controllers have different dynamics.

### BRIEF DESCRIPTION OF THE DRAWINGS

Example embodiments of the invention are explained below with reference to the drawings, in which:

FIG. 1 shows a schematic illustration of an exemplary embodiment of a steering system, and

FIG. 2 shows a schematic illustration of a first embodiment of a monitoring level of the steering system.

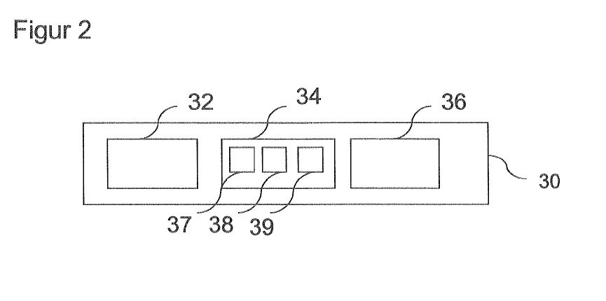

### DETAILED DESCRIPTION

Embodiments of the present invention provide a steering system which can be adapted easily and flexibly when there is a change and/or expansion in vehicle architecture and/or vehicle functions.

Some embodiments provide a steering system for a motor vehicle having actuators for the wheel drive, steering and suspension. The steering system comprises a request level. The request level is assigned first registering units which are each designed to register continuous predefined values of a vehicle user for a movement of the vehicle. Additionally or alternatively, the request level is assigned second registering units which are each designed to register time-discrete predefined values of the vehicle user for the movement of the motor vehicle. The request level is assigned a first processing unit configured to determine a preliminary setpoint movement vector for the motor vehicle as a function of the registered continuous and/or time-discrete predefined values of the vehicle user. Furthermore, the request level is assigned third registering units which are each designed to determine at least one current and/or predictive operating variable for the motor vehicle. In addition, the request level is assigned a second processing unit configured to determine a setpoint movement vector for the motor vehicle as a function of the preliminary setpoint movement vector and the determined operating variables. The steering system also comprises a monitoring level which is assigned a control unit for each of the predefined movement directions of the motor vehicle, wherein the control units are each designed to determine a force vector as a function of the setpoint movement vector and at least one predefined parameter set for a predefined system control function. Furthermore, the steering system comprises an actuation level which is assigned at least one third processing unit configured to determine respective manipulated variables for the actuators as a function of the determined force vectors.

This advantageously makes it possible to provide a steering system with uniquely defined interfaces. This may make a contribution to allowing changes and expansions of the steering system to take place easily. The defined interfaces permit the actuation level to be decoupled from the request level and from the monitoring level. A change in an actuator configuration can therefore take place independently of the request level and the monitoring level. In addition, a change in the request level and/or in the monitoring level can take place independently of a current actuator configuration. This can make a contribution to allowing the vehicle system function to be changed and/or expanded easily and/or to allowing further vehicle system functions to be added very easily. In addition, this can make a contribution to reducing the probability of errors during the development and/or to lowering development costs. The decoupling of the request level from the monitoring level also has the advantage that further automation of the driving ranging as far as autonomous driving can take place independently of the monitoring level, the actuation level and a current actuator configuration of the motor vehicle. During automated driving, the driver of the motor vehicle is still actively involved in the steering of the vehicle as a function of the degree of automation, while in the case of autonomous driving the vehicle driver is essentially no longer involved in the steering of the vehicle.

The respective force vector can respectively represent forces relating to a center of gravity of the motor vehicle in the longitudinal direction, in the vertical direction and/or in the lateral direction and/or a rolling moment and/or a pitching moment and/or a yawing moment. Depending on the respective force vector, a steering angle and/or a steering torque and/or a wheel rotational torque can be determined. The respective operating variable can comprise a measurement variable or a status variable or a further variable derived from measurement variables and/or status variables. The respective operating variable can characterize an operating state and/or driving state and/or a state of the surroundings of the motor vehicle. In order to continuously predefine values for the movement of the motor vehicle, a vehicle user can, for example, activate an accelerator pedal, a brake pedal, a gear speed shift or hold it in a specific position and therefore continuously define predefined values for the movement of the motor vehicle. When an automated driving system or an autonomous driving system is used, a time-discrete predefined value can be issued by the vehicle user by means of a predefined input, for example a one-off input by the vehicle user, for example by means of an input for an autonomous driving system: “drive from a first location to a second location”.

In one embodiment, the at least one third processing unit is designed to determine the respective manipulated variables for the actuators as a function of a current and/or predictive operating variable. This can be advantageously utilized to bring about rapid and sufficiently reliable reactions in critical driving states, for example if the friction of a roadway covering suddenly changes. In addition it is possible to use this to predefine the way in which the required energy is made available and/or to predefine for the respective consumers a maximum proportion of the supplied energy to which they are entitled. For example, it is possible to predefine as a function of a state of charge of an energy accumulator of the motor vehicle whether the motor vehicle is to be braked by means of regeneration braking or friction braking.

In a further embodiment, the setpoint movement vector represents a curvature and an acceleration. This permits very simple and abstract characterization of the predefinition of the motor vehicle user and of driver assistance functions with respect to the movement of the motor vehicle. In addition in this way it is possible to define a clear interface between the request level and the monitoring level.

In a further embodiment, the monitoring level is respectively assigned at least one control unit for a lateral, a vertical and a longitudinal movement direction of the motor vehicle. This has the advantage that the number of control units can be reduced. As a result, on the one hand, it is possible to reduce costs and on the other hand the various control units can easily be adjusted since the control units each control the movement in different movement directions. In addition, when forces acting on a wheel are determined it is necessary to take into account the fact that longitudinal guidance forces and lateral guidance forces acting on a wheel depend on one another and a resulting total force of these two forces cannot exceed a maximum frictional force of the wheel (Kamm's circle). Apportionment of all the control functions among the control units for the lateral movement direction, vertical movement direction and longitudinal movement direction of the motor vehicle advantageously permits simple additive superimposition of the determined forces.

In a further embodiment, the control unit for the lateral movement direction and/or the control unit for the vertical movement direction and/or the control unit for the longitudinal movement direction have/has more than one controller, wherein the controllers each have different dynamics. The movement requests can differ depending on the operating state of the motor vehicle. Very rapid adaptation of an actual movement of the motor vehicle to the movement request is necessary in some cases. This adaptation can also take place slowly in some cases. Providing controllers with different dynamics has the advantage that, with respect to sensitivity and/or transient response, a respectively suitable controller can be selected for adapting an actual movement of the motor vehicle to the movement request.

A known driver assistance system is an adaptive cruise control system (ACC system). The adaptive cruise control system permits the speed of the motor vehicle to be adapted to a predefined value as well as the distance to be adapted to vehicles travelling ahead in that the drive and brake are actuated electronically. Contemporary adaptive cruise control systems have various sensors, for example a camera and/or a radar, by means of which objects can be sensed in the forward driving direction of the motor vehicle. In addition, the adaptive cruise control system has a controller element configured to control an actual speed and an actual distance adaptively with the motor and with braking intervention as a function of a predefined setpoint value for the distance and the speed. The controller element preferably has a longitudinal controller.

A further known driver assistance system is the cruise control system, also referred to as a cruise controller. The cruise control system is designed to control a driving torque in such a way that the motor vehicle maintains, where possible, a speed predefined by the vehicle user. The cruise controller system has a further controller element configured to control an actual speed adaptively with drive interventions as a function of a predefined setpoint value for the speed. The further controller element preferably has a longitudinal controller.

Further driver assistance systems are, for example: an antilock brake system (ABS), traction control system (TCS), autonomous stopping system (emergency stopping system in the event of the driver experiencing health problems), electronic stability program (ESP), engine torque controller, electronic differential lock (EDL), braking assistance system (BAS), automatic emergency brake system (AEBS), hill ascent control system, hill descent control system, inter-vehicle distance warning system, lane detection system, lane keeping assistant/lane assistant (lane departure warning system), lane keeping support system, lane change assistance system, lane change support system, intelligent speed adaptation (ISA) system and parking aid. These driving assistance systems each have separate controller units and have direct coupling to the actuators which are preferred for these driver assistance systems. These driver assistance systems are nowadays mainly embodied as individual systems which are independent of one another. The respective individual system determines actuation variables for actuators to which the individual system has access. Coordination of the various actuator requests of the individual systems is carried out by means of calculation units of the specific actuators. It is very difficult to change the actuator configuration and to change and/or add further driver assistance systems owing to the adaptation of the actuator request for the specific actuators.

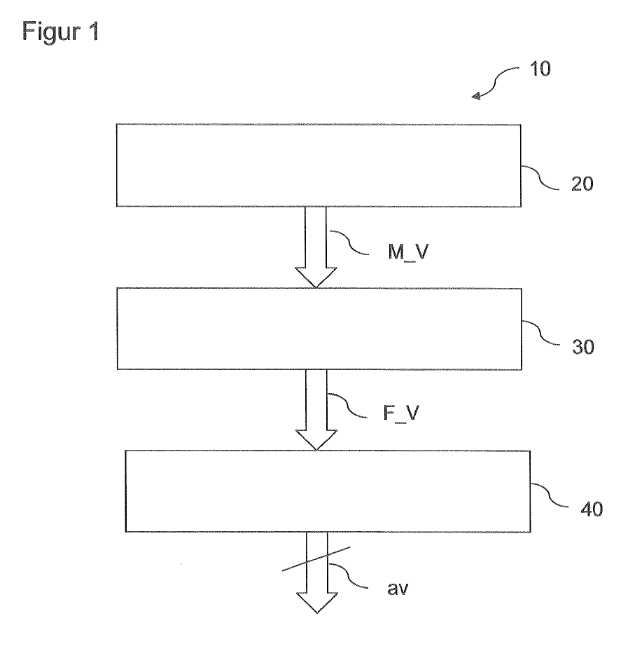

FIG. 1 shows a schematic illustration of a steering system 10 for a motor vehicle according to one embodiment. The steering system 10 has a plurality of levels. The steering system 10 is designed to carry out at least some of the driver assistance functions of the above-mentioned driver assistance systems. In this context, various vehicle functions, for example registering functions, control functions, actuation functions, are not assigned to individual systems, for example to a specific vehicle assistance system, but instead these vehicle functions are assigned to various processing levels.

The motor vehicle for which the steering system 10 is used has actuators for a wheel drive, steering and suspension. The actuators can be, for example, electronically actuated. Motor vehicles can have very different actuator configurations. For example, the vehicle can have one or more drive units, for example an internal combustion engine and/or one or more electric motors. The internal combustion engine can be embodied as a petrol engine or as a diesel engine. The motor vehicle can have one or more energy accumulators and/or the electrical energy can be generated, for example, by means of one or more fuel cells. The brake system of the motor vehicle can comprise a friction brake, a service brake and/or an engine brake. The steering system 10 shown in FIG. 1 has a request level 20. The request level 20 is assigned first registering units which are each designed to register continuous predefined values of a vehicle user for a movement of the vehicle. Additionally or alternatively, the request level 20 is assigned second registering units which are each designed to register time-discrete predefined values of the vehicle user for the movement of the motor vehicle. A vehicle user can activate, for example, an accelerator pedal, a brake pedal, a gear speed shift or keep it in a specific position and thereby continuously specify predefined values for the movement of the motor vehicle. The devices for predefining a movement request by the vehicle user can also comprise future operator control elements such as, for example, a joystick and/or pads and/or a viewing direction detection means. The time-discrete predefined values can preferably be used for automated or autonomous driving of the motor vehicle. A time-discrete predefined value can be, for example, an input for an automated driving system: “park the vehicle in parking space”.

The request level 20 is assigned a first processing unit configured to determine a preliminary setpoint movement vector for the motor vehicle as a function of the registered continuous and/or time-discrete predefined values of the vehicle user.

Furthermore, the request level 20 is assigned third registering units which are each designed to determine at least one current and/or predictive operating variable for the motor vehicle. The third registering units each comprise, for example, at least one sensor. The various sensors may each be designed to register movement data of the motor vehicle, for example the speed, acceleration and/or rotational speed. The sensors can also be designed to register vehicle-internal variables such as, for example, pressures and/or temperatures. In addition, the sensors can be designed to register variables relating to the surroundings of the vehicle. For example, the motor vehicle can have a camera and/or a radar sensor and/or an ultrasonic sensor which can be used to register a distance between the motor vehicle and an object which is located in the driving direction of the motor vehicle. For example, the motor vehicle can have at least a third registering unit configured to register a current and predictive state of charge of an energy store and/or to determine a current and/or predictive energy consumption level of the motor vehicle, the energy being able to be thermal, electrical and/or kinematic energy.

In addition, the request level 20 is assigned a second processing unit configured to determine a setpoint movement vector M_V for the motor vehicle as a function of the preliminary setpoint movement vector and the determined operating variables. The request level 20 combines the predefined values of the vehicle user and of the driver assistance systems relating to the movement of the motor vehicle to form one uniform variable. For example, activation of the brake pedal is converted into a negative wheel torque. In the case of a hybrid vehicle or electric vehicle, this is also converted into a negative wheel torque, for example in the case of regeneration when the accelerator pedal is released. A request by the distance radar is also converted into a negative wheel torque. The wheel torque requests relate to a longitudinal movement of the motor vehicle. Further movement requests relating to a lateral movement of the vehicle can be characterized, for example, by means of a yawing moment. The various wheel torque requests and yawing moment requests are consolidated. For this purpose, the setpoint movement vector M_V is determined, said vector combining the movement requests for various directions, for example in the lateral, vertical and longitudinal directions. In this context, priorities of individual functions can also be taken into account. For example, the priority of an automatic cruise control function system may be higher than that of a cruise control system function with the result that, for example, the movement request of the automatic cruise control system function is prioritized over that of the cruise control system function.

The determined setpoint movement vector M_V can represent, for example, an acceleration and a curvature.

The steering system 10 also comprises a monitoring level 30 which is assigned a control unit 32, 34, 36 for each of the predefined movement directions of the motor vehicle, wherein the control units 32, 34, 36 are each designed to determine a force vector F_V as a function of the setpoint movement vector M_V and at least one predefined parameter set for a predefined system control function.

In a further embodiment, the monitoring level 30 is respectively assigned at least one control unit 32, 34, 36 for a lateral, a vertical and a longitudinal movement direction of the motor vehicle. For example, the control unit 32 can have more than one controller 37, 38, 39 for the lateral movement direction and/or the control unit 36 can have more than one controller 37, 38, 39 for the vertical movement direction and/or the control unit 34 can have more than one controller 37, 38, 39 for the longitudinal movement direction, wherein the controllers 37, 38, 39 can have different dynamics. This makes it possible, for example, during a parked state of the motor vehicle, to use a different longitudinal controller for a request of a parking assistance function than for an adaptive cruise control system function which is active during a driving state of the motor vehicle.

Furthermore, the control system 10 has an actuation level 40 which is assigned at least one third processing unit configured to determine respective manipulated variables av for the actuators as a function of the determined force vector F_V. The actuation level 40 has the function of implementing the force vector F_V on the actuators of the drive, transmission, brakes, damping, suspension and steering. If the force vector F_V represents, for example, a negative wheel torque, this request can be passed on to the electric motor for regeneration, or if relatively strong interventions are necessary, the friction brake can also be used as an actuator. This can take place independently of the state of individual system components, for example of a state of charge of an energy store.

If the motor vehicle is to be returned to a stable vehicle-dynamic state from an unstable state, the force vector F_V can represent, for example, a yawing moment. A yawing moment request can be implemented, for example, by means of a classic individual wheel braking intervention and/or by means of an acceleration of a further individual wheel and/or by means of a steering intervention.

The at least one third processing unit can be designed, for example, to determine the respective manipulated variables av for the actuators as a function of a current and/or predictive operating variable. For example, the respective manipulated variables av for the actuators can be determined as a function of a roadway covering. If, for example, the roadway covering has μ split, it is possible to determine the manipulated variables av in such a way that a suitable individual wheel braking intervention and a steering intervention take place simultaneously in order to achieve the shortest possible braking distance.

In addition, in this way, for example, the method of making available the required energy can be predefined and/or a maximum proportion of the energy provided to which the respective consumers are entitled can be predefined. An energy management system will become ever more important in future motor vehicles, for example in order to reduce CO₂ emissions, and to save Watt hours and kilowatt hours in electric vehicles and/or hybrid vehicles. In order to achieve an optimum in this context, a central energy management system is necessary which has, for example, a direct access to the energy source and energy reduction. A chronologically predicted available amount of energy contrasts with a chronologically predicted energy consumption level. The steering system 10 permits the requirements of the energy management system to be taken into account during the determination of the setpoint movement vector M_V as well as during the determination of the manipulated variables av.

What is claimed is:

1. A steering system for a motor vehicle having actuators for wheel drive, steering, and suspension, the comprising:
a request module comprising:
first registering units configured to register continuous predefined values of a vehicle user for a movement of the vehicle,
second registering units configured to register time-discrete predefined values of the vehicle user for the movement of the motor vehicle,
a first processing unit configured to determine a preliminary setpoint movement vector for the motor vehicle as a function of the registered continuous predefined values and the registered time-discrete predefined values of the vehicle user,
third registering units configured to determine at least one operating variable for the motor vehicle, the at least one operating variable comprising at least one of a current operating variable of the vehicle and a predictive operating variable of the vehicle, and
a second processing unit configured to determine a setpoint movement vector for the motor vehicle as a function of the preliminary setpoint movement vector and the at least one determined operating variables,
a monitoring module comprising a plurality control units, each configured to control movement of the motor vehicle in a different predefined movement direction, wherein each control unit is configured to determine a force vector as a function of the setpoint movement vector and at least one predefined parameter set for a predefined system control function, and
an actuation module comprising at least one third processing unit configured to determine respective manipulated variables for the actuators as a function of the determined force vectors.

2. The steering system of claim 1, wherein the at least one third processing unit is designed to determine the respective manipulated variables for the actuators as a function of a determined operating variable.

3. The steering system of claim 1, wherein the setpoint movement vector represents a curvature and an acceleration.

4. The steering system of claim 1, wherein the plurality of control units comprises control units for each of a lateral movement direction, a vertical movement direction, and a longitudinal movement direction of the motor vehicle.

5. The steering system claim 4, wherein at least one of the control units has multiple controllers for the corresponding movement direction, wherein the multiple controllers have different dynamics.

6. A steering system for a motor vehicle having actuators for wheel drive, steering, and suspension, the steering system comprising:
a request module comprising:
first registering units configured to register predefined values of a vehicle user for a movement of the vehicle, the predefined values comprising at least one of continuous predefined values and time-discrete predefined values for the movement of the motor vehicle,
a first processing unit configured to determine a preliminary setpoint movement vector for the motor vehicle as a function of the registered predefined values of the vehicle user,
second registering units configured to determine at least one operating variable for the motor vehicle, the at least one operating variable comprising at least one of a current operating variable of the vehicle and a predictive operating variable of the vehicle, and
a second processing unit configured to determine a setpoint movement vector for the motor vehicle as a function of the preliminary setpoint movement vector and the at least one determined operating variables,
a monitoring module comprising a plurality of control units, each configured to control movement of the motor vehicle in a different predefined movement direction, wherein each control unit is configured to determine a force vector as a function of the setpoint movement vector and at least one predefined parameter set for a predefined system control function, and
an actuation module comprising at least one third processing unit configured to determine respective manipulated variables for the actuators as a function of the determined force vectors.

7. The steering system of claim 6, wherein the at least one third processing unit is designed to determine the respective manipulated variables for the actuators as a function of a determined operating variable.

8. The steering system of claim 6, wherein the setpoint movement vector represents a curvature and an acceleration.

9. The steering system of claim 6, wherein the plurality of control units comprises control units for each of a lateral movement direction, a vertical movement direction, and a longitudinal movement direction of the motor vehicle.

10. The steering system of claim 6, wherein at least one of the control units has multiple controllers for the corresponding movement direction, wherein the multiple controllers have different dynamics.

11. A method of steering control for a motor vehicle having actuators for wheel drive, steering, and suspension, the method comprising:
registering, by first registering units, predefined values of a vehicle user for a movement of the vehicle, the predefined values comprising at least one of continuous predefined values and time-discrete predefined values for the movement of the motor vehicle,
determining, by a first processing unit, a preliminary setpoint movement vector for the motor vehicle as a function of the registered predefined values of the vehicle user,
registering, by second registering units, at least one operating variable for the motor vehicle, the at least one operating variable comprising at least one of a current operating variable of the vehicle and a predictive operating variable of the vehicle,
determining, by a second processing unit, a setpoint movement vector for the motor vehicle as a function of the preliminary setpoint movement vector and the at least one determined operating variables,
controlling movement of the motor vehicle in a plurality of different predefined movement directions using a plurality of control units, including determining, by each control unit, a force vector as a function of the setpoint movement vector and at least one predefined parameter set for a predefined system control function, and
determining, by at least one third processing unit, respective manipulated variables for the actuators as a function of the determined force vectors.

12. The method of claim 11, wherein comprising determining the respective manipulated variables for the actuators as a function of a determined operating variable.

13. The method of claim 11, wherein the setpoint movement vector represents a curvature and an acceleration.

14. The method of claim 11, wherein controlling movement of the motor vehicle in a plurality of different predefined movement directions comprises controlling movement of the motor vehicle in a lateral movement direction, a vertical movement direction, and a longitudinal movement direction of the motor vehicle.
